(19) United States
(12) Patent Application Publication
(10) Pub. No.: US 2003/0211801 A1
(43) Pub. Date: Nov. 13, 2003

(54) Hydroentangled continuous filament nonwoven fabric and the articles thereof

(76) Inventors: Michael Putnam, Fuquay-Varina, NC (US); Ralph A. Moody III, Mooresville, NC (US); Greg Day, Mooresville, NC (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/339,537

(22) Filed: Jan. 9, 2003

Related U.S. Application Data
(60) Provisional application No. 60/346,971, filed on Jan. 9, 2002.

(51) Int. Cl. B32B 7/08; B32B 5/26

(52) U.S. Cl. 442/387; 442/327; 442/320

(57) ABSTRACT

A three-dimensionally imaged nonwoven fabric, as formed in accordance with the principles of the present invention, contemplates a material formed by hydroentanglement of at least one lightly bonded continuous filament layer upon a device having a three-dimensional foraminous forming surface. The preferred continuous filament substrate is in the form of a precursor web comprising spunbond continuous polymeric filaments. A nonwoven fabric formed in accordance with the present invention may be formed to include substantially continuous filaments (from a relatively lightly bonded spunbond precursor web), with the resulting fabric having a machine direction tensile strength of at least about 1,472 grams per centimeter at 47% machine-direction elongation.

### TECHNICAL FIELD

The present invention relates generally to nonwoven fabrics, and more particularly, to hydroentangled nonwoven fabrics exhibiting desirable softness, strength and bulk characteristics, which are manufactured from at least one layer of lightly bonded continuous filament substrate facilitating efficient and high-speed production, said continuous filament nonwoven fabric being formed upon a three-dimensional image transfer device, and said imaged continuous filament nonwoven fabric being of particular utility in hygiene, industrial, and medical article fabrication.

### BACKGROUND OF THE INVENTION

Nonwoven fabrics are used in a wide variety of applications where the engineered qualities of the fabric can be advantageously employed. These types of fabrics differ from traditional woven or knitted fabrics in that the fibers or filaments of the fabric are integrated into a coherent web without the practice of traditional textile processes. Entanglement of the fibrous elements of the fabric provides the fabric with the desired integrity, with the selected entanglement process permitting fabrics to be patterned to achieve desired utility.

Various prior art patents disclose nonwoven fabrics manufactured by application of a hydroentangling processes. U.S. Pat. No. 3,485,706, to Evans, hereby incorporated by reference, discloses a hydroentanglement process for manufacture of nonwoven fabrics. Hydroentanglement entails the application of high-pressure water jets to webs of fibers or filaments, whereby the fibers or filaments are rearranged under the influence of water impingement. The web is typically positioned on a support surface as it is subjected to impingement by the water jets, whereby the fibers or filaments of the web become entangled, thus creating a fabric with coherency and integrity.

U.S. Pat. No. 5,369,858, to Gilmore et al., discloses an apertured nonwoven fabric formed from melt-blown microfibers using the Evans-type technology. These types of microfibers are attenuated during the practice of well-known melt-blowing formation techniques, whereby the fibers have relatively small diameters and constrained fiber lengths. This patent discloses the use of a belt or drum support. Plural hydroentangling manifolds act against fibers positioned on the forming surface to displace the fibers from “knuckles” of the forming surface, and into openings or lower parts of the forming surface topography, as in Evans. This patent contemplates use of a polymeric net or scrim for fabric formation, and the formation of fabric having apertures therein of two different sizes, including formation of fabric from a first layer of textile fibers or polymeric filaments, and a second layer of melt-blown microfibers.

U.S. Pat. No. 4,805,275, to Suzuki et al., also discloses a method for forming nonwoven fabrics by hydroentanglement. This patent contemplates that hydroentanglement of a fibrous web be effected on a non-three-dimensional smooth-surfaced water-impermeable endless belt.

U.S. Pat. No. 5,516,572, to Roe, discloses a disposable absorbent article including a liquid pervious topsheet, wherein the topsheet comprises a nonwoven fabric prepared from a homogeneous admixture of melt-blown fibers and staple length synthetic fibers. The patent contemplates that fabrics formed in accordance with its teachings comprise a blend including up to 50% by weight of melt-blown fibers.

In contrast to the above-referenced patents, the present invention contemplates a nonwoven fabric employing at least one continuous filament layer and a hydroentangling device having a foraminous forming surface, which results in an efficiently produced nonwoven fabrics having a high degree of tunable aesthetic and/or physical performance properties. Such aesthetic and performance attributes imparted into the resulting imaged nonwoven fabric facilitating use in a wide variety of end-use applications.

### SUMMARY OF THE INVENTION

A three-dimensionally imaged nonwoven fabric, as formed in accordance with the principles of the present invention, contemplates a material formed by hydroentanglement of at least one lightly bonded continuous filament layer upon a device having a three-dimensional foraminous forming surface. The preferred continuous filament substrate is in the form of a precursor web comprising spunbond continuous polymeric filaments. As is known in the art, the formation of a “spunbond” entails extrusion, or “spinning”, of thermoplastic polymeric material with the resultant filaments cooled and drawn, or attenuated, as they are collected. The continuous, or essentially endless, filaments may be bonded to facilitate off-line formation, with the process of the subject invention contemplating that such spunbond material be employed as the precursor web.

The thermoplastic polymers of the spunbond material are chosen from the group consisting of polyolefins, polyamides, and polyesters, wherein the polyolefins are chosen from the group consisting of polypropylene, polyethylene, and combinations thereof. It is within the purview of the present invention that more than one layer of spunbond material may be used in the formation of the precursor web, each layer of spunbond material comprising either the same or different thermoplastic polymers. Further, the spunbond material layer or layers may comprise homogeneous, bi-component, and/or multi-component profiles of the same or differing thermoplastic polymers, as well as, aesthetic and/or performance modifying additives, and the blends thereof.

With the precursor web positioned on the hydroentangling device, hydroentanglement is effected by application of high pressure liquid streams upon the precursor web. Filaments of the precursor web are rearranged on the three-dimensional topography of the device. The forming surface of the device, thus acts in concert with the high pressure liquid streams, to rearrange the filaments of the precursor web.

Notably, the characteristics of the spunbond precursor web, in particular the strength of its bonds, has a direct influence on the strength characteristics of the resultant nonwoven fabric. Development has shown that if the spunbound precursor web is only relatively lightly bonded, hydroentanglement acts to break or disrupt the bonds without substantially breaking the continuous filaments from which the spunbond precursor web is formed. As a consequence, a nonwoven fabric formed in accordance with the present invention may be formed to include substantially continuous filaments (from a relatively lightly bonded spunbond precursor web), with the resulting fabric having a machine direction tensile strength of at least about 1,472 grams per centimeter at 47% machine-direction elongation.

The degree of bonding of the precursor web is specifically selected to facilitate handling of the web, with the contemplation that higher strength fabrics can be achieved if the filaments of the precursor web are maintained in a substantially continuous form. In accordance with the present invention, it is contemplated that the spunbond precursor web is subjected to bonding which provides no more than a minimum tensile strength, which permits winding and unwinding, or similar processing, of the precursor web. Thus, the minimal tensile strength of the precursor web is selected to facilitate efficient handling during manufacturing of the present three-dimensionally nonwoven fabric.

A further embodiment of the present invention is the incorporation of one or more continuous filament layers into a single imaged nonwoven fabric.

It is also within the purview of the present invention that one or more imaged continuous filament nonwoven fabrics may be formed into compound constructs, of either laminate or composite structure, by combination with one or more layers selected from the group consisting of: un-imaged nonwoven fabrics, un-imaged woven fabrics, un-imaged knitted fabrics, imaged nonwoven fabrics, imaged woven fabrics, imaged knitted fabrics, pulp tissues, planar films, apertured films, scrims, supporting sublayers, and the combinations thereof.

Further, a secondary material layer may be essentially planar, or be formed so as to have the same, or different, three-dimensional image as the essential imaged continuous filament nonwoven layer. Other aesthetic or performance modifying fillers, such as absorbents, soaps, or medicinals, may be included between the at least one imaged continuous filament nonwoven layer and the at least one secondary material layer.

In the construction of end-use articles, particularly hygiene articles, the ability to thermally bond the imaged continuous filament nonwoven fabric, whether as a single layer, or as a compound fabric has also been found to be highly advantageous.

Other features and advantages of the present invention will become readily apparent from the following detailed description, the accompanying drawings, and the appended claims.

### BRIEF DESCRIPTION OF THE DRAWINGS

FIG. 1 is a diagrammatic view of a hydroentangling apparatus for practicing the process of the present invention, whereby imaged continuous filament nonwoven fabrics embodying the principles of the present invention can be formed;

FIG. 2 is a diagrammatic view of an alternate hydroentangling apparatus for practicing the process of the present invention.

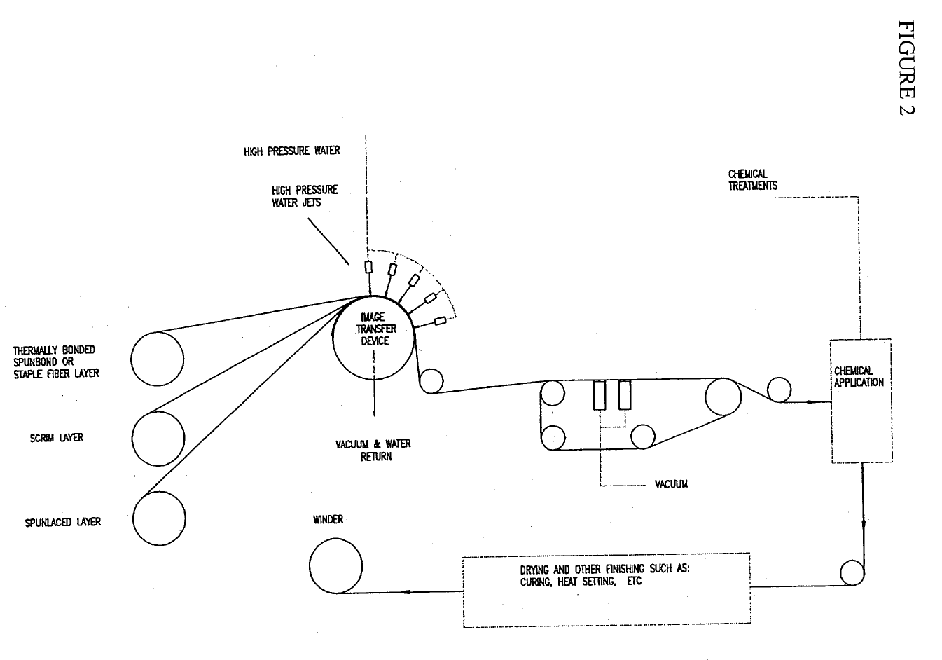

FIG. 3 is a plan view of a three-dimensional image transfer device of the type used for practicing the present invention, referred to herein as “hexagon-Z”;

FIG. 4 is a plan view of a three-dimensional image transfer device of the type used for practicing the present invention, referred to herein as “square-Z”;

FIG. 5 is a plan view of a three-dimensional image transfer device of the type used for practicing the present invention, referred to herein as “bar-Z”;

FIG. 6 is a plan view of a three-dimensional image transfer device of the type used for practicing the present invention, referred to herein as “crisscross-Z”;

FIG. 7 is a plan view of a three-dimensional image transfer device of the type used for practicing the present invention, referred to herein as “no hole-Z”;

FIG. 8 is a plan view of a three-dimensional image transfer device of the type used for practicing the present invention, referred to herein as “large segmented diamond”;

FIG. 9 is a plan view of a three-dimensional image transfer device of the type used for practicing the present invention, referred to herein as “wave”;

FIG. 10 is a plan view of a three-dimensional image transfer device of the type used for practicing the present invention, referred to herein as “large basket weave”;

FIG. 11 is a plan view of a three-dimensional image transfer device of the type used for practicing the present invention, referred to herein as “large square”;

FIG. 12 is a plan view of a three-dimensional image transfer device of the type used for practicing the present invention, referred to herein as “zig-zag”;

FIG. 13 is a plan view of a three-dimensional image transfer device of the type used for practicing the present invention, referred to herein as “large honeycomb”;

FIG. 14 is a photomicrograph of a three-dimensional image nonwoven fabric of the present invention, having a “20×20” image imparted therein, magnification is about 12×;

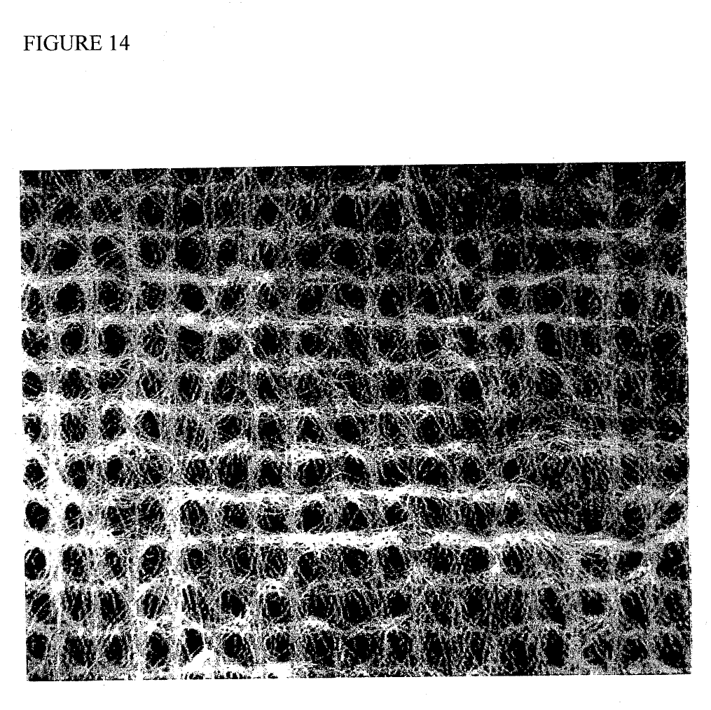

FIG. 15 is a top-plan view of a three-dimensional image nonwoven fabric of the present invention, having a “8×20” image imparted therein, magnification is about 12×;

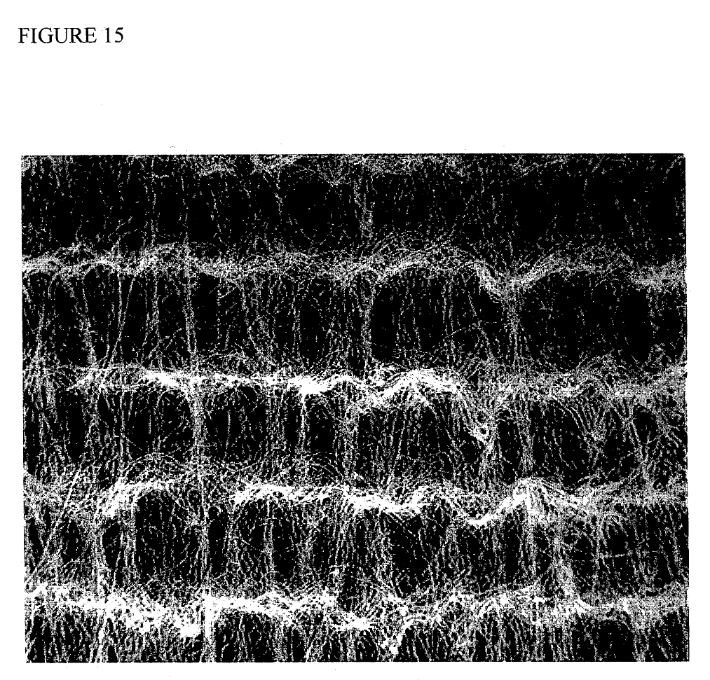

FIG. 16 is a plan view of a disposable diaper article; and

FIG. 17 is a front view of a protective garment article.

### DETAILED DESCRIPTION

While the present invention is susceptible of embodiment in various forms, there is shown in the drawings and will hereinafter be described a presently preferred embodiments, with the understanding that the present disclosure is to be considered as an exemplification of the invention, and is not intended to limit the invention to the specific embodiment illustrated.

The present invention relates generally to nonwoven fabrics, and more particularly, to hydroentangled nonwoven fabrics exhibiting desirable softness, strength, and bulk characteristics, which are manufactured from at least one layer of lightly bonded continuous filament substrate facilitating efficient and high-speed production, said continuous filament nonwoven fabric being formed upon a three-dimensional image transfer device, and said imaged continuous filament nonwoven fabric being of particular utility in hygiene, industrial, and medical article fabrication.

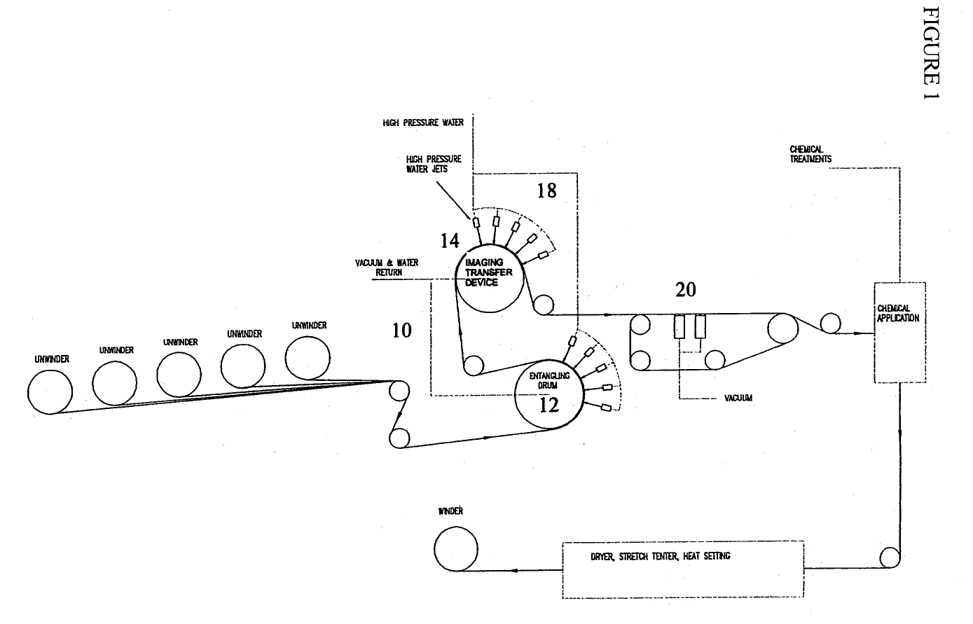

With reference to FIG. 1, therein is illustrated a hydroentangling apparatus, generally designated 10, which can be employed for practicing the formation of a three-dimensionally imaged continuous filament nonwoven fabric. The apparatus is configured generally in accordance with the teachings of U.S. Pat. No. 5,098,764, to Drelich et al., hereby incorporated by reference. The apparatus 10 includes an entangling drum 12 and an imaging drum 14. Imaging drum 14 comprises a hydroentangling device having a three-dimensional foraminous forming surface upon which hydroentangling of a precursor web is effected for formation of the present nonwoven fabric.

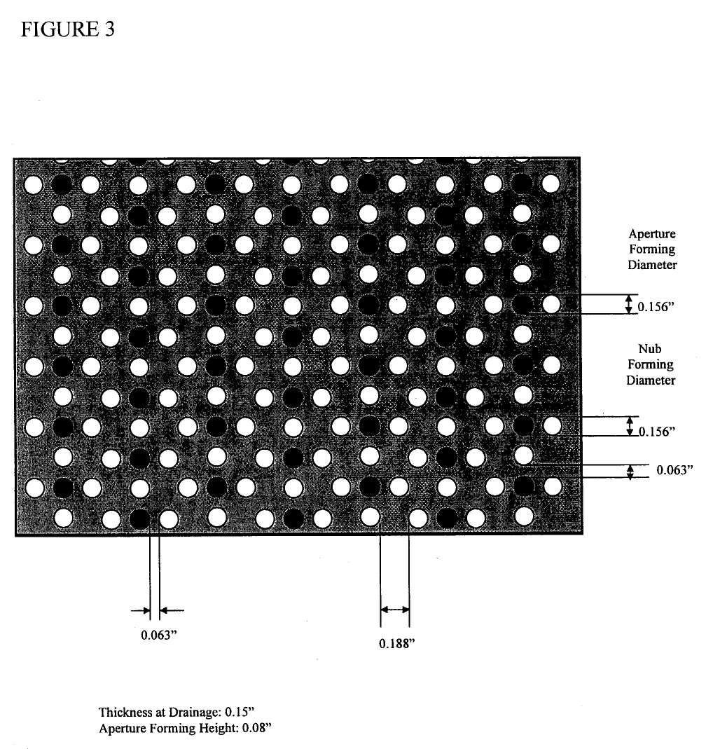

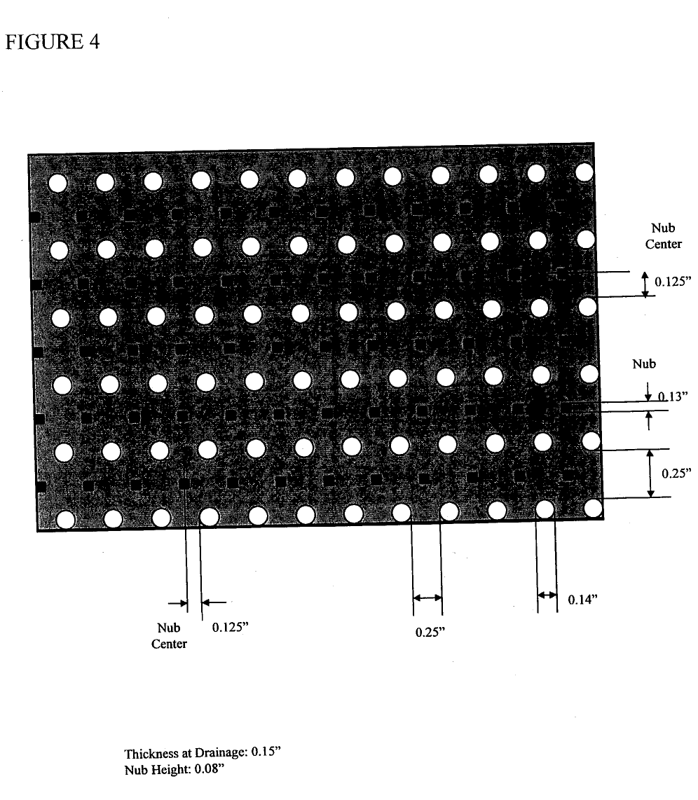

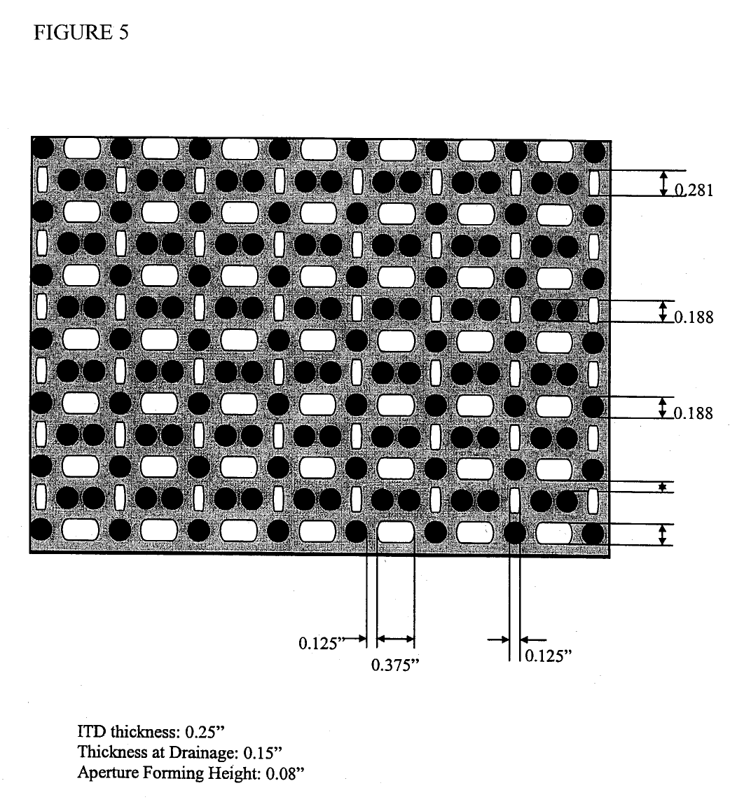

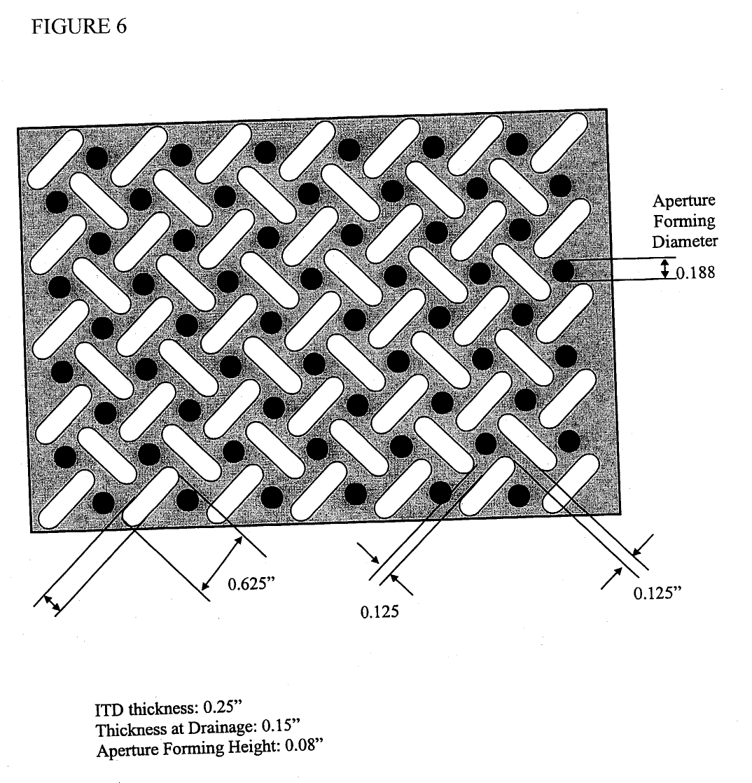

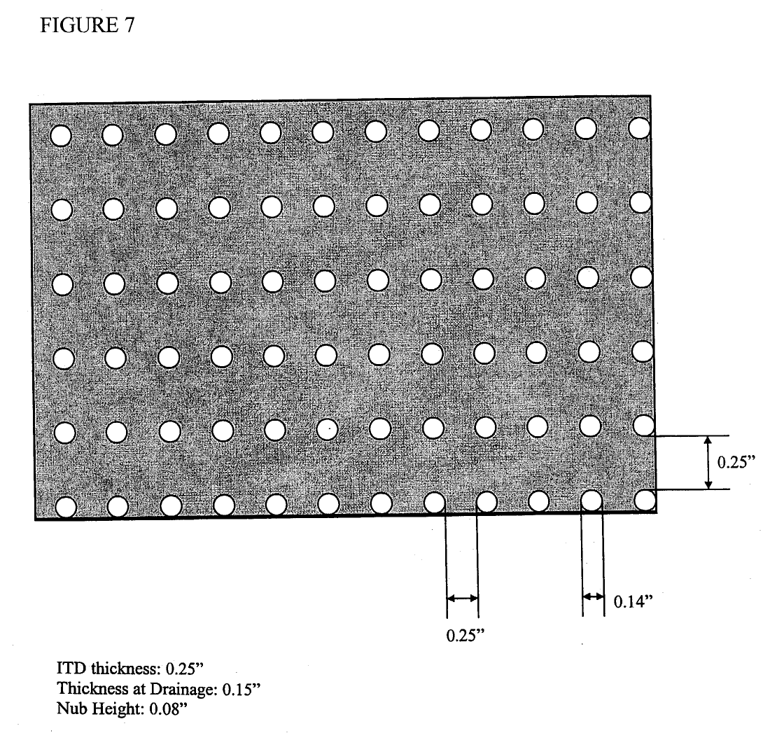

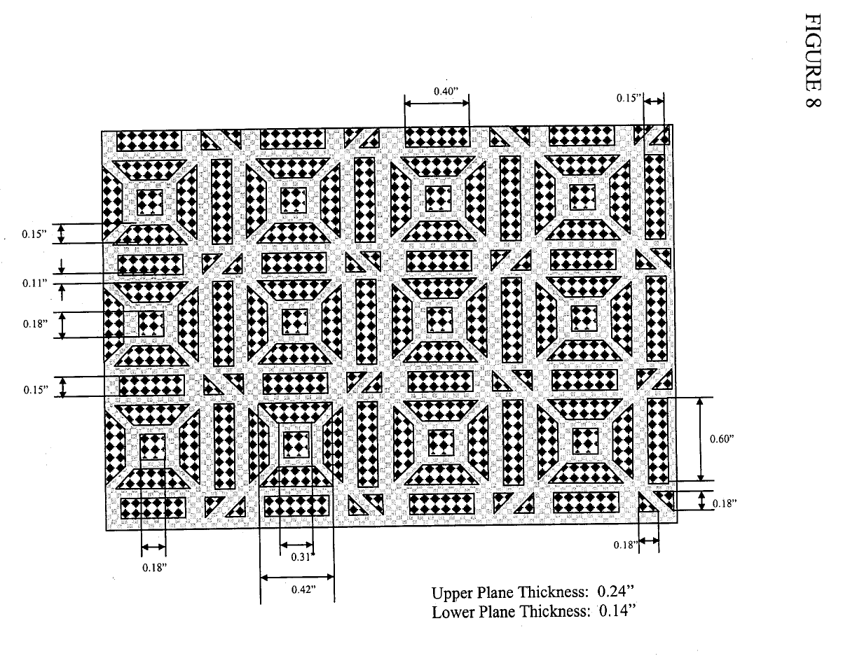

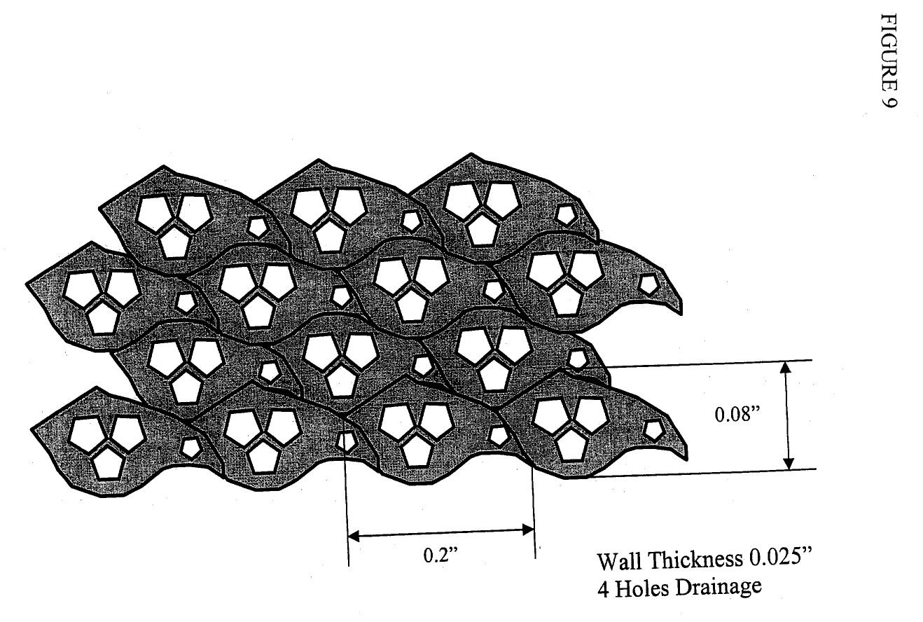

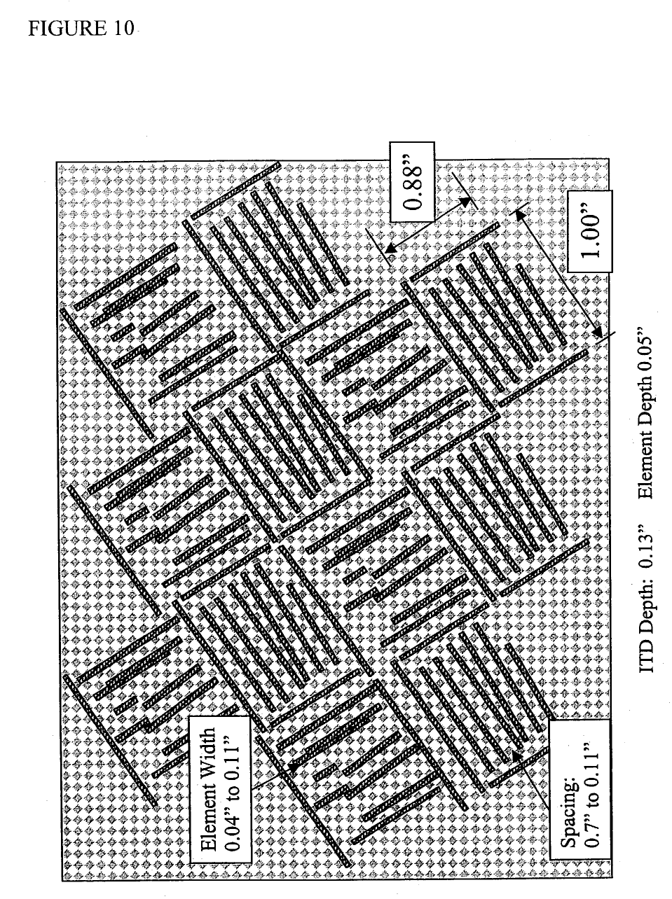

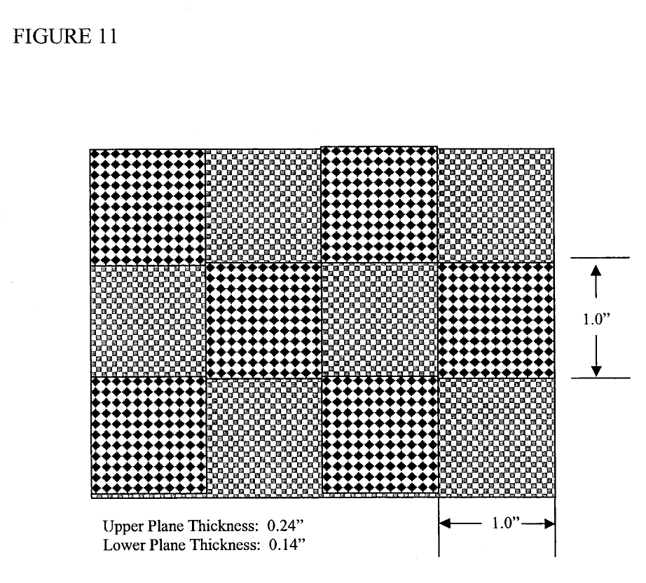

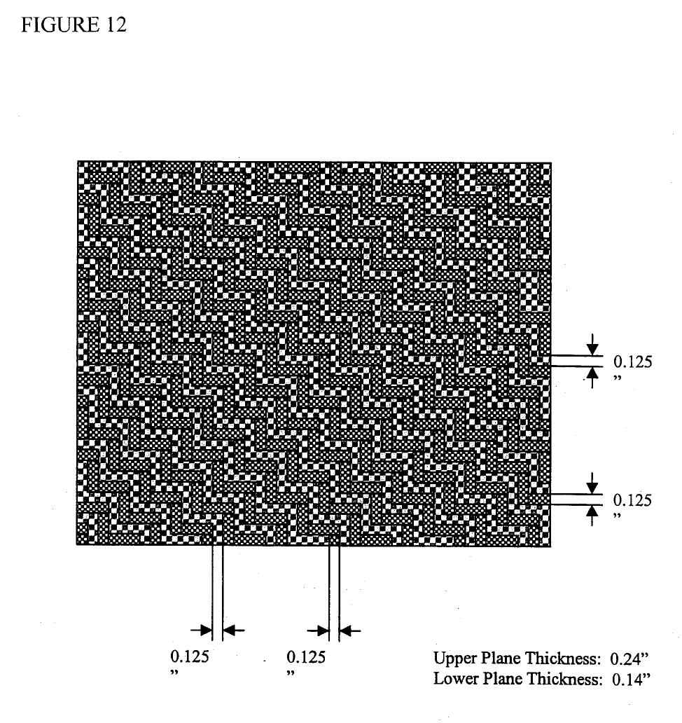

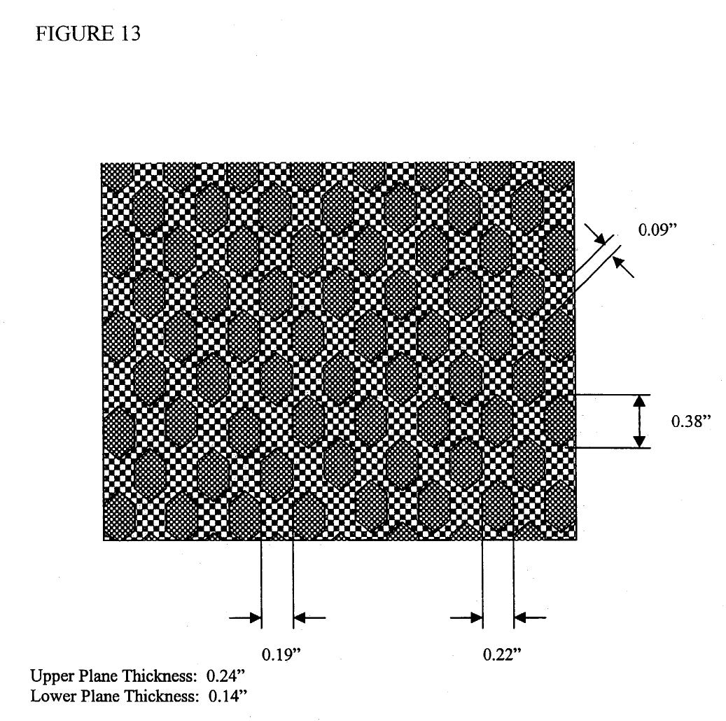

The image transfer device shown as imaging drum 14, can be selected from a broad variety of three-dimensional image types. Exemplary FIGS. 3, 4, 5, 6 and 7, are three-dimensional images of the “nub” type. Fibrous nubs are formed during the process of entangling on the imaging drum 14, these nubs extending out of the planar background of the resulting fabric. These fibrous nubs can act as high points with which to distance the nonwoven fabric from a contact surface. FIGS. 8, 11, 12, and 13, are examples of a “geodesic” type of image. In this image type, regular blocks of entangled constituent filaments extended out of the planar background, the fibrous blocks creating, for example, particulate capturing asperities useful in cleaning wipes, dusting cloths and exfoliating facial wipes. FIGS. 9 and 10 represent images of the “natural” type. Due to the flexibility inherent to the fabrication of the image on the image transfer device, variations in three-dimensional image including multi-planar images, variations in image juxtaposition, and the ability to create complex images having controlled discontinuities allow for the creation of textures in textiles not seen in the art. Apertures, or holes, can also be created in the nonwoven fabric, regardless of image type. Such apertures can allow for air transfer between layers when combined in a compound construct, and/or can be used to allow the passage of liquid, particularly human exudates, through the plane of the material and into the transfer layer or absorbent core of a disposable hygiene article.

While it is within the purview of the present invention to employ various types of precursor webs, including fibrous and continuous filament webs, it is presently preferred to employ spunbond continuous filament webs comprising thermoplastic polymer filaments. Filament denier is preferably in the range of about 0.2 to 10.0, with the range of 1.5 to 2.2 denier filaments being particularly preferred for general applications. The precursor web preferably has a basis weight from about 10 to 300 grams per square meter, more preferably from about 15 to 130 grams per square meter, and most preferably in the range of about 30 to 90 grams per square meter. Use of continuous filament precursor webs is presently preferred because the filaments are essentially endless, and thus facilitate use of relatively high energy input during entanglement without undesirably driving filaments into a image transfer device of the entangling drum, as can occur with staple length fibers or mel;t-blown microfibers. The preferred use of filamentary precursor webs permits the filament to be subjected to elevated hydraulic energy levels without undesirable fouling of the three-dimensional forming surface. Thus, fabrics are formed continuously and at economical rates, without substantially altering the basis weight of the precursor webs or inducing rate related deleterious aesthetic effects.

A particular benefit of finished fabrics formed in accordance with the present invention is uniformity of three-dimensional imaging. Fiber movement from the water jets from the hydroentangling manifolds is controlled by the shape and depth of the forming surface and drainage design. The use of higher pressures and flows is desirably achieved, thus permitting processing of webs at high speeds and lower basis weights. Finished products are produced at operating speeds of up to hundreds of feet per minute. The following is an example of an imaged continuous filament nonwoven fabric formed in accordance with the present invention. Reference to manifold pressures is in connection with water pressure, in pounds per square inch (psi), in hydroentangling manifolds 18, illustrated in FIG. 1. Each of these manifolds included orifice strips having 33.3 holes or orifices per inch, each having a diameter of 0.0059 inches. The example was made using a single pass beneath the hydroentangling manifolds, with each manifold acting against the same side of the precursor web to form the resultant fabric. Testing of fabrics was conducted in accordance with ASTM testing protocols.

A lightly bonded precursor web, as referenced below, may be produced on a commercial spunbond production line using standard processing conditions, except thermal point bonding calender temperatures are reduced, and may be at ambient temperature (sometimes referred to as cold calendering). For example, during production of standard polyester spunbond, the thermal point bonding calender is set at a temperature of 200 to 210 degrees C. to produce the bonded finished product. In contrast, to prepare a similar precursor web for subsequent entangling and imaging, the calender temperature is reduced to 160 degrees C. Similarly, during production of standard polypropylene spunbond products, the common thermal point calender conditions are 300 degrees F., and 320 pounds per linear inch (PLI) nip pressure. For a lightly bonded polypropylene precursor web to be entangled and imaged, these conditions are reduced to 100 degrees F. and 100 PLI.

### EXAMPLE 1

A relatively lightly bonded spunbond polyester precursor web was employed having a basis weight of 28 grams per square meter, with 1.8 denier filaments. The precursor was lightly bonded as described above. The precursor web was entangled at 80 feet per minute, with successive manifold pressures of 700, 4,000, and 4,000 psi. Energy input was 3.2 horse-powerhour per pound. The resultant fabric exhibited a basis weight of 32.4 grams per square meter, a bulk of 0.470 millimeter, a cross-direction strip tensile strength of 327 grams per centimeter, at a cross-direction elongation of 72%, and a machine direction strip tensile strength of 1,472 grams per centimeter at a machine direction elongation of 47%. The fabric thus exhibited a strip tensile strength of at least 45 grams-force per centimeter per gram per square meter.

The precursor web used in the above Example which was characterized as lightly bonded were formed as specified, whereby the precursor web was bonded to exhibit no more than a minimal tensile strength which permits winding and unwinding of the web. If hydroentanglement is effected in-line with production of a spunbond precursor web, the precursor web may be lightly bonded to a sufficient degree as to permit efficient movement of the precursor web into the hydroentangling apparatus.

It will be noted from the above that Example 1 exhibited relatively high tensile strength characteristics per given basis weight. It has been observed that this is a result of the degree of bonding of the precursor web for the various examples. In Example 1, a relatively lightly bonded precursor web was employed and it is believed that when this type of web is subjected to hydroentanglement, there is a disruption of the bonds, without significant breakage of the polymeric filaments of the precursor web. In contrast, precursor webs that were used during development which were relatively well-bonded, exhibited less strength. It is believed that during hydroentanglement, disruption of the well-formed filament bonds resulted in a relatively higher degree of filament breakage.

Fabrics formed in accordance with the present invention are desirably strong, exhibiting desirable softness and bulk characteristics. Fabrics produced in accordance with the present invention are useful for nonwoven disposable products such as diaper facing layers, with the present fabrics exhibiting improved softness compared to typical spunbond materials. The present fabrics are preferable to thermally bonded lightweight webs, which tend to be undesirably stiff. It is believed that fabrics in accordance with the present invention can be readily employed in place of traditional point bonded, latex bonded, and hydroentangled staple length nonwoven fabrics, dependent upon basis weight and performance requirements.

As illustrated in FIG. 1, subsequent to hydroentanglement, the fabric being formed may be subjected to dewatering, as generally illustrated at 20, with chemical application (if any) and typical drying of the fabric thereafter effected.

It is within the purview of the present invention that at least one secondary material layer can be combined with the imaged continuous filament layer. Technologies capable of forming a secondary material layer include those which form continuous filament nonwoven fabrics, staple fiber nonwoven fabrics, continuous filament or staple fiber woven textiles (to include knits), and films. Fibers and/or filaments comprising the secondary material layer are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for use generally include polyolefins, polyamides and polyesters. The thermoplastic polymers may be further selected from homopolymers; copolymers, conjugates and other derivatives including those thermoplastic polymers having incorporated melt additives or surface-active agents.

The secondary material layer may be combined with the imaged continuous filament layer by such suitable means as represented by adhesive bonding, thermal bonding, hydroentanglement, and the combinations thereof. In the construction of end-use articles, particularly hygiene articles, the ability to thermally bond the imaged continuous filament nonwoven fabric, whether as a single layer, or as a compound fabric is highly advantageous.

Manufacture of nonwoven compound fabrics embodying the principles of the present invention includes the use of fibers and/or filaments having different composition. Differing polymeric resins can be compounded with the same or different aesthetic and performance improvement additives. Further, fibers and/or filaments may be blended with fibers and/or filaments that have not been modified by the compounding of additives.

Continuous filament nonwoven fabric formation, involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the meltblown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203, incorporated herein by reference. The meltblown process, as well as the cross-sectional profile of the spunbond filament or meltblown microfiber, is not a critical limitation to the practice of the present invention.

Suitable nano-denier continuous filament barrier layers can be formed by either direct spinning of nano-denier filaments or by formation of a multi-component filament that is divided into nano-denier filaments prior to deposition on a substrate layer. U.S. Pat. Nos. 5,678,379 and 6,114,017, both incorporated herein by reference, exemplify direct spinning processes practicable in support of the present invention. Multi-component filament spinning with integrated division into nano-denier filaments can be practiced in accordance with the teachings of U.S. Pat. Nos. 5,225,018 and 5,783,503, both incorporated herein by reference.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric desired. The fibrous batt is integrated into a nonwoven fabric by application of suitable bonding means, including, but not limited to, use of adhesive binders, thermobonding by calender or through-air oven, and hydroentanglement.

The production of conventional textile fabrics is known to be a complex, multi-step process. The production of staple fiber yarns involves the carding of the fibers to provide feedstock for a roving machine, which twists the bundled fibers into a roving yarn. Alternately, continuous filaments are formed into bundle known as a tow, the tow then serving as a component of the roving yarn. Spinning machines blend multiple roving yarns into yarns that are suitable for the weaving of cloth. A first subset of weaving yarns is transferred to a warp beam, which, in turn, contains the machine direction yarns, which will then feed into a loom. A second subset of weaving yarns supply the weft or fill yarns which are the cross direction threads in a sheet of cloth. Currently, commercial high-speed looms operate at a speed of 1000-1500 picks per minute, whereby each pick is a single yarn. The weaving process produces the final fabric at manufacturing speeds of 60 inches to 200 inches per minute.

The formation of finite thickness films from thermoplastic polymers, suitable as a strong and durable substrate layer, is a well-known practice. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed material, or dispensed directly onto a secondary substrate material to form a composite material having performance of both the substrate and the film layers. Examples of suitable secondary substrate materials include other films, polymeric or metallic sheet stock, and woven or nonwoven fabrics.

Extruded films utilizing the composition of the present invention can be formed in accordance with the following representative direct extrusion film process. Blending and dosing storage comprising at least one hopper loader for thermoplastic polymer chip and, optionally, one for pelletized additive in thermoplastic carrier resin, feed into variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the additive into the thermoplastic polymer. The polymer chip and additive pellet blend feeds into a multi-zone extruder. Upon mixing and extrusion from the multi-zone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

When a secondary substrate material is to receive a film layer extrusion, a secondary substrate material source is provided in roll form to a tension-controlled unwinder. The secondary substrate material is unwound and moves over the nip roll. The molten film extrusion from the extrusion die is deposited onto the secondary substrate material at the nip point between the nip roll and the cast roll to form a strong and durable substrate layer. The newly formed substrate layer is then removed from the cast roll by a stripper roll and wound onto a new roll.

Breathable barrier films can be combined with the improved aesthetic and performance properties imparted by combining a breathable barrier film with an imaged continuous filament nonwoven fabric layer. Monolithic films, as taught in U.S. Pat. No. 6,191,211, and microporous films, as taught in U.S. Pat. No. 6,264,864, both patents herein incorporated by reference, represent the mechanisms of forming such breathable barrier films.

A secondary material layer may be essentially planar, or be formed so as to have the same, or different, three-dimensional image as the essential imaged continuous filament nonwoven layer. Further, other aesthetic or performance modifying fillers may be included between the at least one imaged continuous filament nonwoven layer and at least one secondary material layer.

Utilizing the above-discussed single and multi-layer manufacturing technologies, utilizing at least one imaged continuous filament nonwoven layer, a number of end-use articles can benefit from the inclusion or substitution of a pre-existing layer or layers, including, but not limited to, such articles as disposable, semi-durable, and durable applications in hygiene, medical, and industrial fields.

Disposable waste-containment garments are generally described in U.S. Pat. Nos. 4,573,986, 5,843,056, and 6,198,018, which are incorporated herein by reference.

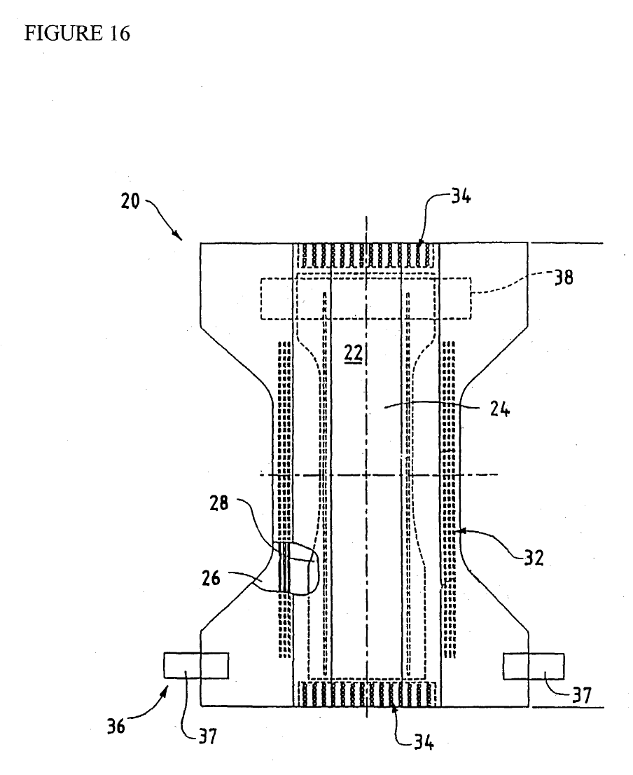

An absorbent article incorporating an imaged continuous filament fabric of the present invention is represented by the unitary disposable absorbent article, diaper 20, shown in FIG. 16. As used herein, the term “diaper” refers to an absorbent article generally worn by infants and incontinent persons that is worn about the lower torso of the wearer. It should be understood, however, that the present invention is also applicable to other absorbent articles such as incontinence briefs, incontinence undergarments, diaper holders and liners, feminine hygiene garments, training pants, pull-on garments, and the like.

FIG. 16 is a plan view of a diaper 20 in an uncontracted state (i.e., with elastic induced contraction pulled out) with portions of the structure being cut-away to more clearly show the construction of the diaper 20. As shown in FIG. 16, the diaper 20 preferably comprises a containment assembly 22 comprising a liquid pervious topsheet 24; a liquid impervious backsheet 26 joined to the topsheet; and an absorbent core 28 positioned between the topsheet 24 and the backsheet 26. The absorbent core 28 has a pair of opposing longitudinal edges, an inner surface and an outer surface. The diaper can further comprise elastic leg features 32; elastic waist features 34; and a fastening system 36, which preferably comprises a pair of securement members 37 and a landing member 38.

Practical application of an improved barrier fabric comprising imaged continuous filament fabric as described in this invention for backsheet 26 results in a diaper that is lighter in weight while maintaining performance. A lighter weight backsheet material is expected to be more flexible and therefore more conforming to deformation of the overall structure as the diaper is applied and worn. An imaged continuous filament fabric can also be employed as the liquid pervious topsheet, particularly when an aperture forming image is used in the manufacture of the material, to improve the control of human exudates, and specifically loose bowel movements, from inducing a critical failure of the absorbent article.

Catamenial products, such as feminine hygiene pads, are of the same general construction as the aforementioned diaper structure. Again, a topsheet and a backsheet are affixed about a central absorbent core. The overall design of the catamenial product is altered to best conform to the human shape and for absorbing human exudates. Representative prior art to such article fabrication include U.S. Pat. Nos. 4,029,101, 4,184,498, 4,195,634, 4,408,357 and 4,886,513, which are together incorporated herein by reference.

Cleansing and cleaning wipes are generally described in the prior art, as represented by U.S. Pat. Nos. 6,280,757, 6,074,655, 5,951,991, 5,605,749, 4,690,821, 6,217,854, 6,063,390 and applicants copending application Serial No. 60/308,331, filed Jul. 27, 2001.

Application of the material of the present invention allows for cleaning aids, for both home and body, which exhibit reduced inherent elongation properties, while benefitting significantly from enhanced physical and aesthetic properties, as represented by; improved ductile and tactile softness, increased material bulk improving the exfoliation and lathering performance, and the ability of the continuous filaments to resist disentanglement, linting, and loss of three-dimensionality. Further, selection of differing filament deniers during formation of the precursor webs allows for the creation of cleaning wipes that have varying frictional coefficients.

Medical and industrial protective products, such as CSR, gauzes and absorbent packings, medical gown, surgical drape and protective oversuits can benefit significantly from the inclusion of an improved barrier fabric as described in the present invention. Of particular utility in the fabrication of such protective products is the use of lighter weight fabrics with improved barrier to weight ratios, as it is important for the finished product to be as lightweight as possible and yet still perform its desired function. The low elongation properties of the imaged continuous filament layer, or layers, is beneficial in forming gauze materials, which resists deformation when placed under a wet load. Patents generally describing such protective products include U.S. Pat. Nos. 4,845,779, 4,876,746, 5,655,374, 6,029,274, and 6,103,647, which are together incorporated herein by reference.

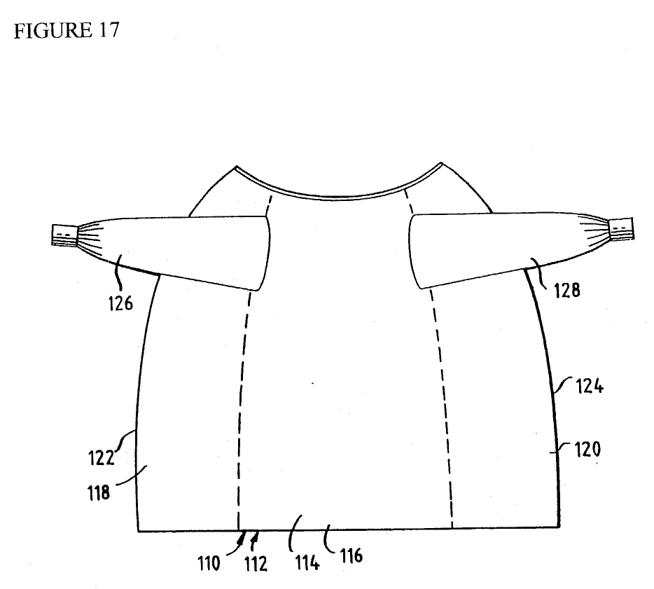

Referring now to FIG. 17, there is shown a disposable garment generally designated 110 comprising a surgical gown 112. The gown 112 comprises a body portion 114, which may be one-piece, having a front panel 116 for covering the front of the wearer, and a pair of back panels 118 and 120 extending from opposed sides of the front panel 116 for covering the back of the wearer. The back panels 118 and 120 have a pair of side edges 122 and 124, respectively, which define an opening on the back of the gown. The gown 112 has a pair of sleeves 126 and 128 secured to the body portion 114 of the gown for the arms of the wearer. In use, the back panels 118 and 120 overlap on the back of the wearer in order to close the back opening of the gown, and suitable belt means (not shown) is utilized to secure the back panels 118 and 120 in the overlapping relationship.

From the foregoing, numerous modifications and variations can be effected without departing from the true spirit and scope of the novel concept of the present invention. It is to be understood that no limitation with respect to the specific embodiments disclosed herein is intended or should be inferred.

What is claimed is:

1. A nonwoven fabric, comprised of a plurality of essentially continuous thermoplastic filaments, said thermoplastic filaments imparted with a three-dimensional image by impingement of fluid streams, said three-dimensional image imparting apertures to said imaged, continuous filament nonwoven fabric, said nonwoven fabric having a strip tensile of at least 45 grams-force per centimeter per grams per square meter.

2. A nonwoven fabric, comprised of first and second layers, said first layer comprising a plurality of essentially continuous thermoplastic filaments, said thermoplastic filaments imparted with a three-dimensional image by impingement of fluid streams, said nonwoven fabric having a strip tensile of at least 45 grams-force per centimeter per grams per square meter, and said second layer comprising at least one material selected from the group consisting of un-imaged nonwoven fabrics, un-imaged woven fabrics, un-imaged knitted fabrics, imaged nonwoven fabrics, imaged woven fabrics, imaged knitted fabrics, pulp tissues, planar films, apertured films, scrims, supporting sublayers, and the combinations thereof.

3. A nonwoven fabric as in claim 2, wherein the first and second layers are joined by a means selected from the group consisting of adhesive bonding, thermal bonding, hydroentanglement, and the combinations thereof.

4. A nonwoven fabric, comprised of first and second layers, said first layer comprising a plurality of essentially continuous thermoplastic filaments, said thermoplastic filaments imparted with a three-dimensional image by impingement of fluid streams, said three-dimensional image imparting apertures to said imaged, continuous filament nonwoven fabric, said nonwoven fabric having a strip tensile of at least 45 grams-force per centimeter per grams per square meter, and said second layer comprising at least one material selected from the group consisting of un-imaged nonwoven fabrics, un-imaged woven fabrics, un-imaged knitted fabrics, imaged nonwoven fabrics, imaged woven fabrics, imaged knitted fabrics, pulp tissues, planar films, apertured films, scrims, supporting sublayers, and the combinations thereof.

5. A nonwoven fabric, in accordance with claim 2, further comprising an aesthetic or performance modifying filler positioned between said first and second layer.

6. A nonwoven fabric, in accordance with claim 4, further comprising an aesthetic or performance modifying filler positioned between said first and second layer.
